(19) United States
(12) Patent Application Publication
(10) Pub. No.: US 2019/0291194 A1
(43) Pub. Date: Sep. 26, 2019

(54) SAW GUARD

(71) Applicant: S & E PETERSEN PROPERTIES PTY LTD., Fitzroy (AU)

(72) Inventor: Simon Joseph Petersen, Albert park (AU)

(21) Appl. No.: 16/434,931

(22) Filed: Jun. 7, 2019

Related U.S. Application Data
(63) Continuation-in-part of application No. PCT/AU2017/051296, filed on Nov. 24, 2017.

(30) Foreign Application Priority Data
Dec. 9, 2016 (AU) 2016905313

(51) Int. Cl. B23D 59/00; B23D 49/10; B23D 51/01

(52) U.S. Cl. CPC B23D 59/00; B23D 51/01; B23D 49/10

(57) ABSTRACT

A saw 10 has a handle 11 and a blade 12 projecting from the handle. The blade 12 has an edge 14 along which a plurality of saw teeth 15 project. The saw 10 further includes a flexible and retractable saw guard 20 which is connected to the saw 10 and which is retractable from a guard position in which the saw guard 20 overlies the saw teeth 14 and a retracted position in which the saw teeth 14 are exposed.

### CROSS-REFERENCE

The present application claims priority from Australian provisional patent application no. 2016905313 filed 9 Dec. 2016, the contents of which should be understood to be incorporated into this specification by this reference.

### FIELD OF THE INVENTION

The present invention relates to a guard for the blade of a saw, in particular a hand saw. The present invention is intended to provide a guard that operates to prevent accidental injury to persons using or handling a hand saw.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Hand saws typically include a metal blade that projects from a handle. In some saws, “hack” and “bow” saws for example, there is a connection to the blade at either end of the blade, with a handle being positioned at one of the connected ends. In other hand saws, the blade extends from the handle and is free at the opposite end. In all saws, cutting teeth are provided or project from one edge of the blade. The teeth can be fine or coarse depending on the intended use of the saw. Because the teeth usually remain exposed when the saw is not in use, a general drawback of saws is that the teeth can present a potential safety hazard to persons using or handling the saw.

Given the above described drawbacks, saw guards have been proposed in the past. Examples of prior arrangements include folded cardboard or moulded plastic that fits over the toothed edge of the saw blade. These saw guards are applied to the blade manually and can adequately protect a user of the saw when properly fitted between saw uses. However, such saw guards can often be misplaced or lost given that they are completely removed from the saw while it is in use, while the structural integrity of the guards can fail well in advance of the failure of the saw blade (particularly the cardboard versions) so that the guard can no longer be used. It follows that these types of guards do not have a form which is robust and permanent.

An object of the present invention is to ameliorate the aforementioned disadvantages of the prior art or to at least provide a useful alternative thereto.

### SUMMARY OF THE INVENTION

According to the present invention there is provided a saw having a handle and a blade projecting from the handle, the blade having an edge along which a plurality of saw teeth project, the saw further including a flexible and retractable saw guard which is connected to the saw and which is retractable from a guard position in which the saw guard overlies the saw teeth and a retracted position in which the saw teeth are exposed.

A saw according to the invention advantageously provides a saw guard that is connected to the saw so that it cannot be lost or misplaced. This overcomes one of the disadvantages of the prior art in which guards can be lost or misplaced once they are removed from the saw for use of the saw. A saw according to the invention also advantageously provides a convenient arrangement in which the guard can be extended to the guard position when the saw is not in use and thereafter can be retracted to the retracted position when the saw is to be used. The retraction and extension operation can be arranged to be simple and easy so that use of the saw guard to protect persons using or handling the saw is not difficult or inconvenient. Also, the saw guard can include markings to function as a convenient tape measure.

A saw according to the invention can be of either kind discussed above in which the blade is either connected at each end (as in “hack” and “bow” saws) by a frame that extends between the handle at one end and the remote or distal end of the blade at the other end, or at one end (the handle end) only—(as in standard hand saws). However, the invention has been developed in relation to saws which have a blade connected at the handle end only and which are free at the end remote from the handle and so further discussion will be made in relation to that form of saw construction.

The saw guard can be fixed in the guard position in any suitable manner. In some forms of the invention, one end of the saw guard (the distal end) is fixed at the end of the saw blade remote from the handle in the guard position. The end of the saw blade remote from the handle can be the very end edge of the saw blade, or it can be in the vicinity of the end edge. This fixing can be by any suitable cooperation between the saw guard and the blade of the saw. In other forms of the invention the fixing can be between the saw guard and the frame of the saw (as used in “hack” and “bow” saws). Suitable fixing can include cooperation between an opening in the saw blade or frame and a pin or projection of the saw guard, or abutment between facing surfaces of the saw blade or frame and the saw guard.

In other forms of the invention, cooperation between the saw guard and the blade of the saw includes the saw guard gripping opposite side surfaces of the saw blade in the guard position. This can be the sole manner of cooperation between the saw guard and the saw blade, or it can be in addition to other forms of cooperation as discussed above. Thus, in some forms of the invention, both of an end fixing and side gripping of the saw guard to the saw blade is provided.

With each of the above forms of fixing of the saw guard in the guard position, release from these fixing positions is required for retraction of the saw guard to the retracted position. More specific details of the forms of fixing of the saw guard in the guard position will be given below.

The saw guard can be connected to the saw in any suitable manner and can be retractable also in any suitable manner. In some forms of the invention, a retraction mechanism is provided which provides both the connection of the saw guard to the saw, as well as the mechanism to retract the saw blade from the guard position. Such a retraction mechanism can provide for automatic retraction once the cooperation between the saw guard and the saw blade or frame is released to allow retraction. A spring biased spool can be used for this purpose. In other forms of the invention, the saw guard can be manually retracted.

The retraction mechanism can include a spool to which the saw guard is connected and the spool can be biased to rotate in a retracting direction. Advantageously, by biasing the spool to retract, retraction of the saw guard can be automatic once the saw guard is released from any connection to the saw blade or frame in the guard position. Also, the continued or permanent bias of the spool on the saw guard can maintain the saw guard in tension and assist to maintain the saw guard properly in position overlying the teeth of the saw blade. Extension of the saw guard from the retracted position can be by pulling on the saw guard itself against the bias of the spool.

Alternative arrangements can include a tensioning device or a biasing mechanism that applies a bias to the saw guard and that is separate to the bias of the spool. A suitable tensioning device or 26 biasing mechanism can include a spring biased abutment that is biased in a direction to apply tension to the saw guard when the saw guard is in the fully extended condition and the saw guard can have an abutment or surface that engages the spring biased abutment in the extended condition of the saw guard. The cooperating engagement between the spring biased abutment and the saw guard should be at or towards the trailing end of the saw guard and preferably at or within the handle of the saw. The saw guard can engage the spring biased abutment just prior to reaching the fully extended condition so that the biasing mechanism applies tension to the saw guard as the saw guard reaches the fully extended condition.

Alternatively, the spool can be driven manually to retract the saw guard, although a biased spool is preferred. A manual spool can include a finger grip for manual rotation of the spool. Manual rotation is only likely to be required for retraction of the saw guard as extension of the saw guard can be by pulling on the saw guard itself.

The spool can connect directly to the saw guard. In that form of the invention, the saw guard can wrap around the spool as the saw guard retracts from the guard position. Not all of the saw guard will necessarily need to wrap around the spool for complete retraction of the saw guard but rather, a portion of the saw guard can wrap around the spool and a portion of the saw guard can remain separate from the spool. The portion that is separate from the spool can be a portion that is positioned in the retracted position of the saw guard for gripping by the saw user, for subsequent extension of the saw guard to the guard position. That is, the spool might be in an inaccessible position so that a tail or trailing portion of the saw guard might be left available for gripping in the retracted position of the saw guard.

In other forms of the invention, the spool can connect to an intermediate member to which the saw guard is connected. In this form of the invention, a flexible string, wire, thread, cord or line (hereinafter “line”) can connect to the spool and to a proximal end of the saw guard and as the saw guard retracts, the line wraps around the spool. In this form of the invention, the saw guard can be retracted by the action of the spool rotating, but the saw guard does not wrap around the spool, or only a very small portion wraps around the spool. This allows for a small spool to be employed as the spool only needs to accommodate the line and not the more bulky saw guard.

In a saw according to the invention, the saw guard can be retracted to any suitable position relative to the saw. In a particularly advantageous form of the invention, the saw can be provided with a hollow or semi hollow handle and the saw guard can be retracted fully or substantially into the handle in the retracted position. This advantageously protects the saw guard while the saw is being used and conveniently removes the saw guard as an obstruction to the sawing process or as an irritant to the saw user by confining or containing the saw guard within the handle.

Preferably, the spool is also housed within the interior of the handle. The spool is preferably sprung by a coil spring and adapted to recoil to draw in the saw guard to the retracted position or to pay out the guard under tension to the guard position.

Where the saw guard is retracted fully or substantially into the handle in the retracted position, the interior of the handle can include a track about which the saw guard is retracted. The track can cause the saw guard to form a loop, coil or spiral within the handle in the retracted position so that the space for accommodating the saw guard within the handle is minimized. That is, by causing the saw guard to form one or more loops, coils or spirals within the handle, the saw guard can be compacted within the handle. Where the retraction mechanism includes a flexible line connected to the spool at one end and to a proximal end of the saw guard at the other end, the line can be retracted about the track as it wraps around the spool to drag the saw guard about the track.

The retraction mechanism can operate without a spool and thus in some forms of the invention, the saw guard can be manually pushed into the retracted position from the guard position and that pushing motion can cause the saw guard to move about a track within the handle if provided. In this form of the invention, the retraction mechanism could be such as to retain the saw guard in the retracted position until the saw guard is manually moved back to the guard position. This differs from the arrangement discussed above in which the spool is biased towards the retracted position as the bias of the spool will act in that arrangement to retain the saw guard in the retracted position.

Many saw handles will include an opening through which the fingers of a saw user will extend and the track within the handle can cause the saw guard to loop, coil or spiral about that opening. In some forms of the invention, the opening will be defined by a wall or walls and internally of the handle, the wall or walls can form the track or part of the track.

Other saw handles will include a handle without an opening and in those forms of the invention, the fingers of a saw user will wrap around to the handle. In these forms of the invention, the handle can be hollow or semi hollow and can include an internal track if required for causing the saw guard to loop, coil or spiral within the handle.

In some forms of the invention, the track can be formed as an integral part of the handle of the saw and the spool can be mounted to an internal surface of the handle. The spool can be mounted for example on a boss, spigot or axle that extends from an internal surface of the handle. However, in alternative forms of the invention, either or both of the track and spool can be formed separately from the handle, such as being formed as a cartridge, for insertion into the interior of the handle. Thus, the invention can be fitted to existing saws with hollow or semi hollow handles, without redesigning or reconfiguring the handle but rather, the cartridge can formed to be inserted into the handle during manufacture or assembly of the saw.

As described above, the saw guard can be fixed in the guard position by attachment of one end of the saw guard (the distal end) to an end of the saw blade. For this, the saw blade can include a notch, recess or opening in an edge surface of the saw blade for connection with a component of the saw guard. The notch, recess or opening can be formed in the edge of the saw blade that includes the teeth, or in a different edge. Alternatively, the saw blade can include an opening inboard of the edge of the saw blade, again for connection with a component of the saw guard. Where the saw blade is under tension from a biased spool for example, then the connection between the end of the saw guard and the saw blade can be one which is maintained in place by the tension applied to the saw guard. This can be a simple form of connection whereby a component of the saw guard is received within the notch, recess or opening of the saw blade and the tension in the saw guard retains the connection until the connection is manually released.

In an alternative arrangement, the end of the saw guard connects to the free end of the saw blade without the need to engage within a notch, recess or opening of the saw blade. The end of the saw guard could for example extend about the free end of the saw blade and engage with the top edge of the saw blade, whereby the top edge is the edge which is opposite the edge of the saw blade from which the teeth project. The end of the saw guard could alternatively engage with the free end of the saw blade if the free end was oriented in a direction that allowed connection and retention of the end of the saw guard in the guard position.

The saw guard can take any suitable form. In some forms contemplated to date, the saw guard can be a rubber strip or channel that is retractable.

In other forms of the invention, the guard can comprise a plurality of links that are hingedly connected together to form an elongate chain. The hinge connection gives the saw guard its flexibility to retract and extend as required while the links can be made from durable plastics that will last the lifetime of the saw and that can provide reliability in relation to the requirement for repeated retraction and extension. Advantageously, suitable plastic links can be selected to minimize or eliminate jamming and stretching.

The links of the saw guard can be of any suitable form. The links can form a channel on one side so that in the guard position, the teeth of the saw blade are partially or fully accommodated within the channel. The arrangement can be such that as the saw guard is extended to the guard position, the channel of the saw guard travels along the edge of the saw blade from which the teeth extend, progressively accommodating the full or major portion of the saw blade teeth as the saw guard travels to the guard position. In this respect, in this form of the invention and all other forms of the invention, while the preference is for full coverage of the saw blade teeth, it remains within the scope of the invention for the saw guard to cover a major portion of the saw blade teeth rather than completely covering all of the saw blade teeth.

In other forms of the invention, the saw guard can be extended from the retracted position spaced from and without contact with the saw blade teeth and when fully or substantially extended, the saw guard can be placed or pressed into contact with the saw blade teeth for coverage. The saw guard can grip the saw blade teeth by friction for example, or can simply overlie them.

The saw guard can conveniently be marked or configured to also act as a measuring device so that it has a dual function of saw guard and measure (similar to a tape measure). Where the saw guard comprises a plurality of links that are hingedly connected together to form an elongate chain, each link can be formed to represent a unit of measure, such as 10 mm in metric, or half or one inch in imperial.

### BRIEF DESCRIPTION OF THE DRAWINGS

The invention may be better understood from the following non-limiting description of preferred embodiments, in which:

FIG. 1 is a side view of a saw incorporating a saw guard according to the invention, with the saw guard in a retracted position.

FIG. 2 is the side view of the saw of FIG. 1 with the saw guard in an extended position.

FIG. 3 is a view of a section of the saw guard illustrated in FIG. 2.

FIG. 4 is an end view of the saw blade of the saw of FIG. 1 with the saw guard shown in a connected and extended position.

FIG. 5 is an end view of the saw blade of the saw of FIG. 1 with the saw guard shown in a disconnected and extended position.

FIG. 6 is a view of the saw of FIG. 1 with the saw guard shifted to a disconnected position.

FIG. 7 is an exploded view of the saw of FIG. 1.

FIG. 8 is a partially assembled view showing the handle and a portion of the blade of the saw of FIG. 1.

FIG. 9 is an exploded view of a cartridge arrangement according to the invention.

FIG. 10 is a partially assembled view of the cartridge arrangement of FIG. 9.

FIG. 11 is a schematic view of a biasing mechanism that can be incorporated in to a saw according to the invention.

### DETAILED DESCRIPTION OF THE DRAWINGS

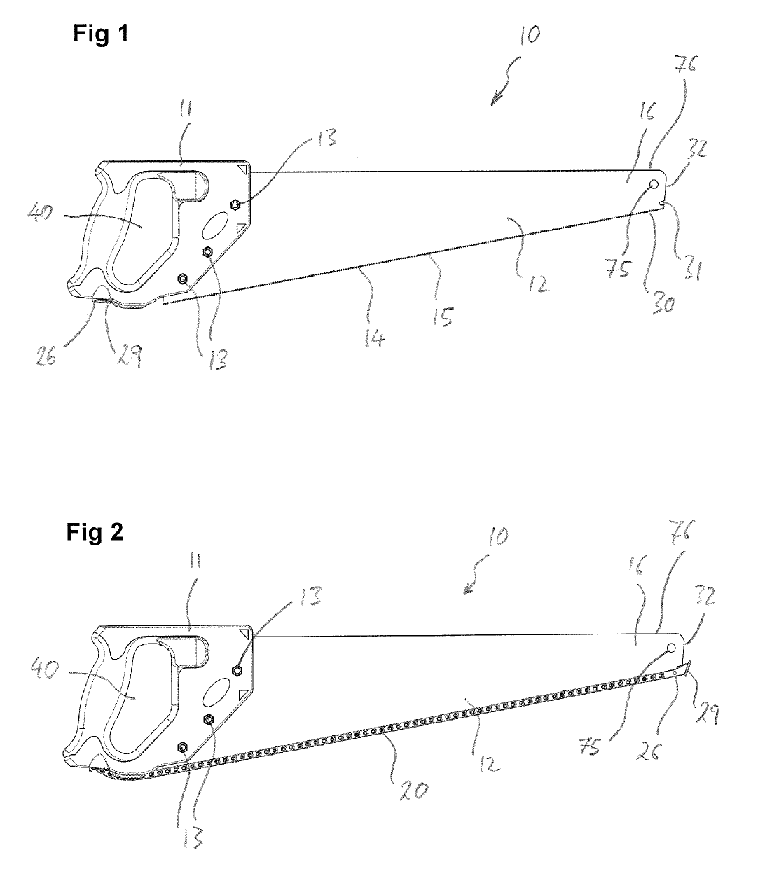

FIGS. 1 and 2 are views taken from the side of a saw 10, known generally as a hand saw or a rip cut saw. The hand saw 10 includes a handle 11 and a saw blade 12. The blade 12 projects from the handle 11 and is attached to the handle 11 by bolt connectors 13. The bolt connectors 13 extend through openings in the blade 12 as will be shown in later figures herein.

The saw blade 12 includes an edge 14 along which a plurality of saw teeth 15 project. The teeth 15 are shown as being fine teeth but depending on the particular saw and its intended use, the teeth can be more coarse. Also, the blade has a free end 16 remote from the handle 11 although the invention also applies to saws in which the blade is connected at both ends, such as is the case in hack saws and bow saws.

The saw 10 includes a saw guard 20 which is accommodated within an interior space of the handle 11 and which is extendable from a retracted position which is shown in FIG. 1, to a guard position which is shown in FIG. 2. In the position shown in FIG. 1, the saw guard 20 is retracted back to the enclosed position within the handle 11 shown in FIG. 1.

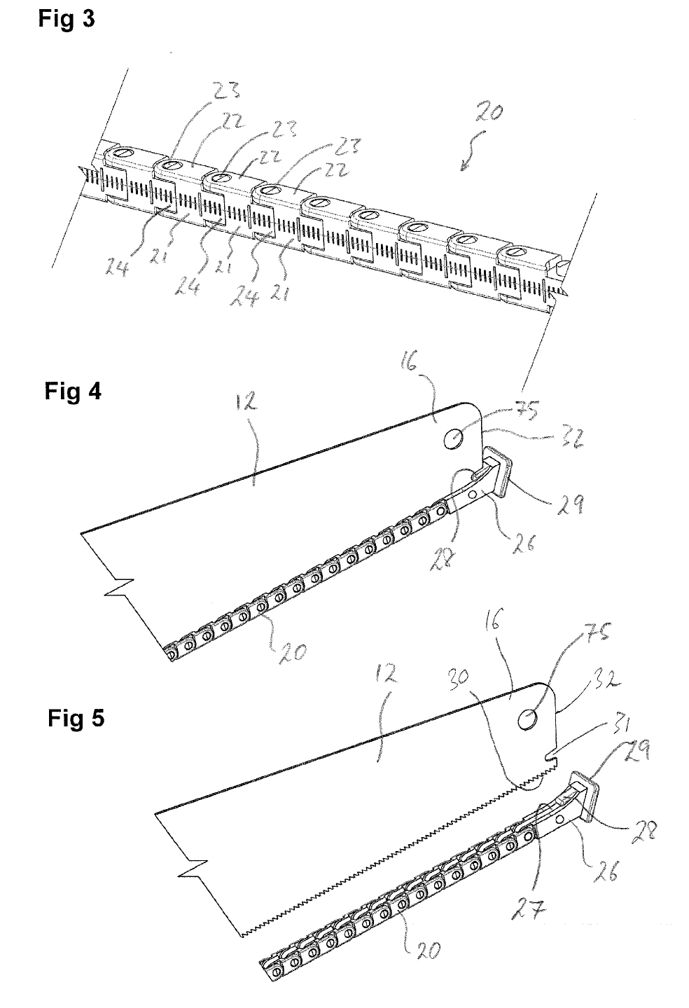

The saw guard 20 is formed from a plurality of individual links that are hingedly connected together to form an elongate chain. FIG. 3 illustrates a section of the saw guard 20 and illustrates the individual chain links 21. It can be seen from FIG. 3, that each link includes a main body 22 and at one end, a pin or axle 23 extends laterally across the link 21 and connects to a projection 24 formed as part of an adjacent link 21. This linkage arrangement connects respective links 21 together in the elongate chain form illustrated.

The link arrangement illustrated in FIG. 3 gives the saw guard 20 significant flexibility in one plane to enable it to form loops or coils within the handle 11 in the retracted position. The saw guard 20 has limited or negligible flexibility lateral to that plane. Moreover, the links allow the saw guard 20 be extended to the position shown in FIG. 2 and to adopt the substantially straight orientation that is shown in FIG. 2. It is to be understood that alternative materials and structures for saw guard 20 could be employed, but the link arrangement illustrated is relatively easy to manufacture from robust plastic materials and is preferred at this stage.

The saw guard 20 is formed with an end connector 26 which is shown in more detail in FIGS. 4 and 5. The end connector 26 in configured to connect with the saw blade 12 at the free end 16 as shown in FIGS. 2 and 4, and to provide an abutment with the handle 11 as shown in FIG. 1. The end connector 26 defines a channel 27, a catch 28 and an abutment 29. The channel 27 is provided to accommodate the leading edge 30 of the saw teeth 15, while the catch 28 is provided to engage within the notch, recess or opening 31 formed in the leading edge 32 of the blade 12. Upon receipt of the catch 28 within the notch 31, tension applied to the saw guard 20 retains that connection and thus retains the saw guard 20 in the covering or protective guard position shown in FIGS. 2 and 4.

The abutment 29 abuts against a facing surface of the handle 11 in the retracted position of the saw guard 20. This terminates further retraction of the saw guard 20 to within the handle 21 upon engagement of the abutment 29 with a facing surface of the handle 11. The abutment 29 also presents a grip portion for gripping by a user of the saw to extend the saw guard 20 from within handle 11.

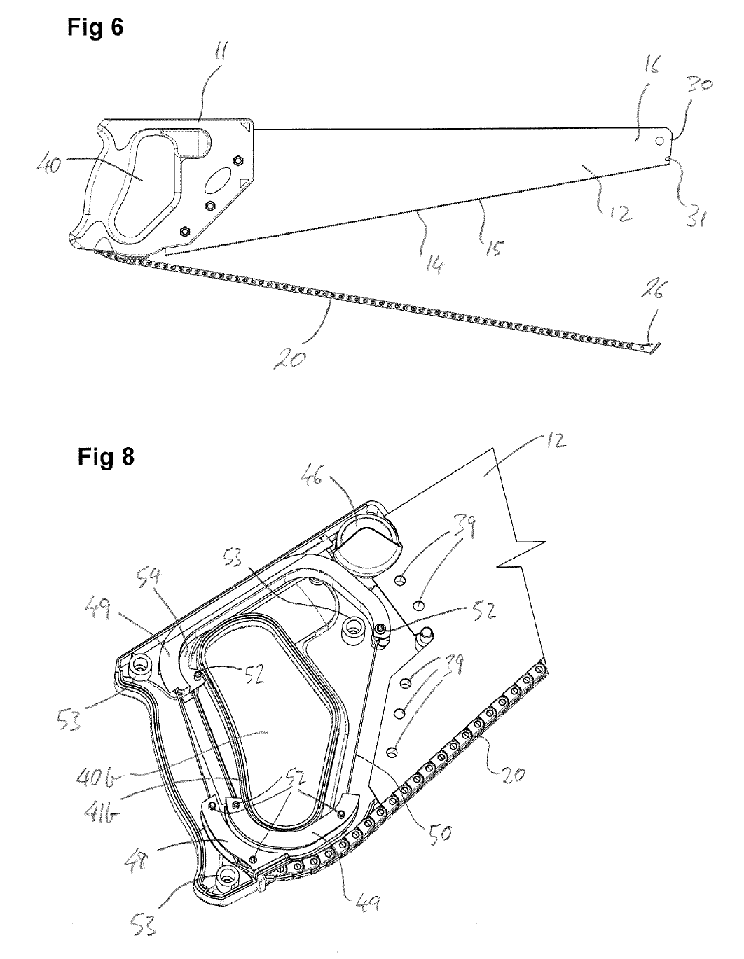

It will be readily evident that the FIG. 4 view shows the end connector 26 connected to the free end 16 of the saw blade 12 by receipt of the catch 28 within the notch 31. It will also be evident that the connection between the catch 28 and the notch 31 can be displaced simply by grasping the abutment 29 and pulling the connector 26 forward to release the catch 28 from the notch 31. Thereafter, the saw guard 20 can be shifted to a position out of connection with the blade edge 14 as is shown in FIG. 6. In that position, the saw guard 20 can be allowed to retract under the influence of a spool bias as hereinafter described.

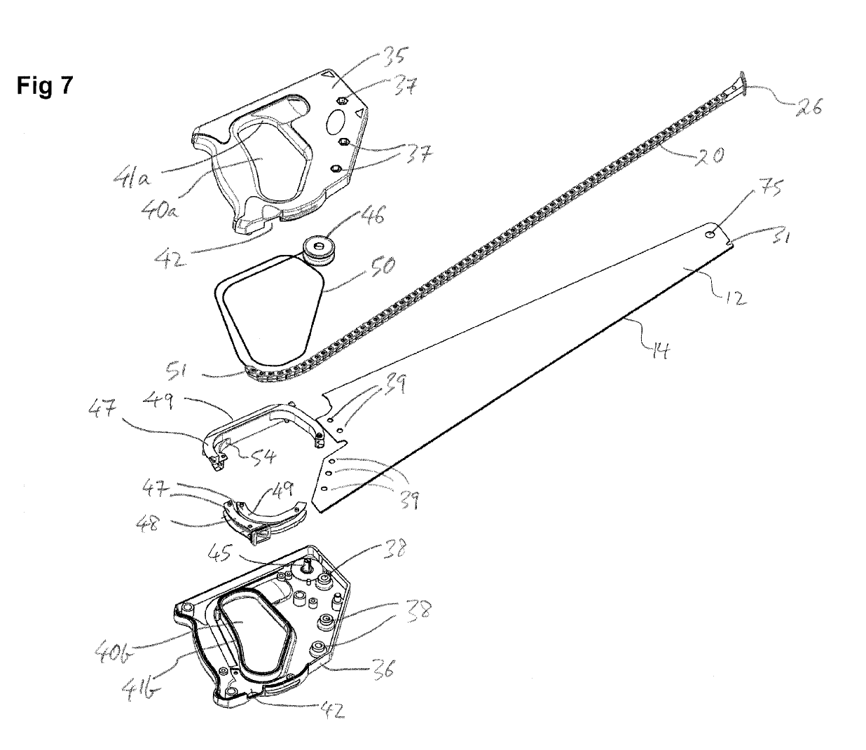

FIG. 7 is an exploded view of the saw 10 of the earlier figures. FIG. 7 thus shows the handle 11 in two connectable parts 35 and 36. The parts 35 and 36 include openings 37 and 38 for receipt of the bolt connectors 13 (which are not shown in FIG. 7 but which appear in FIGS. 1, 2 and 6) for connecting the handle 11 to the saw blade 12. The bolt connectors 13 extend through three of the five openings 39 which are provided in the saw blade 12 at the end that connects to the handle 11. As shown in FIGS. 1, 2 and 6, the handle 11 defines an opening 40 through which the fingers of a user of the saw 10 can extend to grip the handle 11. The opening 40 is formed in the handle parts 35 and 36 by openings 40a and 40b. The opening 40 is defined by an upright wall 41a and 41b that extends inwardly from each of the handle parts 35 and 36 and which meet to form a continuous wall to define the opening 40.

The handle parts 35 and 36 also define sections of an opening 42 which meet to form an opening through which the saw guard 20 extends and retracts from/into the handle 11. The opening is sized to allow the links 21 of the saw guard 20 to retract into and extend from the interior of the handle 11, but is too small for the abutment 29 to pass through. The abutment 29 thus sits about the outside of the opening 42 when the saw guard 20 is in the retracted position.

FIG. 7 shows an upstanding axle 45 and a spool 46. In the assembled form of the handle 11, the spool 46 is mounted on the axle 45 for rotation relative to the axle 45. Moreover, the spool 46 is sprung by a coil spring and thus is biased to rotate in a direction to retract the saw guard 20. This coil spring mechanism is not illustrated in the figures, but such sprung spools are readily available and well known.

Guard tracks 47 are shown in FIG. 7 and these are intended to be fixed in place within the handle 11 to form guides for retraction of the saw guard 20. The tracks 47 comprise an entry track 48 and a top and bottom guide tracks 49.

The tracks 47 are provided to cause the saw guard 20 to loop or spiral about the opening 40 of the handle 11. As shown in FIG. 7, a line 50 attaches to a proximal end 51 of the saw guard 20 and to the spool 46. The path of the line 50 about the track 47 is shown in FIG. 7 and from that path, it can be seen that the line 50 and later the saw guard 20 is retracted about an outer track and then and inner track prior to the final approach to the spool 46. It is not intended that the links of the saw guard 20 actually engage with the spool 46, but rather, it is intended that the track or path that the saw guard 20 takes within the handle 11 is sufficient to allow the proximal end 51 of the saw guard 20 to remain at least slightly spaced away from the spool 46 in the fully retracted condition of the saw guard 20 within the handle 11.

The tracks 47 can be fitted to the handle part 36 either simply by placing those parts in position and then attaching the other handle part 35 in place and fixing the two parts 35 and 36 together, or the tracks can additionally be either adhesively fixed in place or connected by fasteners. In the arrangement shown, the tracks 47 are fixed in place on pins 52 (see FIG. 8) opposite ends of which are received in openings in each of the parts 35 and 36 so that when the parts 35 and 36 are connected together, they secure the pins 52 and thus tracks 47 in position.

Assembly of the saw 10 also involves threading the line 50 through the tracks 47 and placing the spool 46 on the axle 45. When the parts 35 and 36 are connected together, the spool 46 is secured in place on the axle 45.

FIG. 8 illustrates each of the components illustrated in FIG. 7, in an assembled view, but without the handle part 35. In FIG. 8, pins 52 are illustrated which fix the tracks 48 and 49 in place relative to the handle part 36. Opposite ends of the pins are received within openings in the respective handle parts 35 and 36, some of which can be seen in FIG. 7. Moreover, tubes 53 are readily visible in FIG. 8 and these are provided on the handle part 36 for receipt of locating pins that extend from the handle part 35, but which are not shown in either of FIG. 7 or 8. This is a standard form of fastening two plastic components together.

It can be seen from FIG. 8, that the saw guard 20 enters the interior of the handle 11 through the opening 46 (see FIG. 7) and immediately enters the entry track 48. The line 50 extends through the entry track 48 and into the top guide track 49, about the top guide track 49 and then into the bottom guide track 49 which is adjacent to the entry track 48. The line extends about a second section 54 (see FIG. 7) of the top guide track 49 and thereafter to the spool 46. Thus, the saw guard 20 will extend in a single loop within the handle 11 for complete retraction of the saw guard 20 within handle 11.

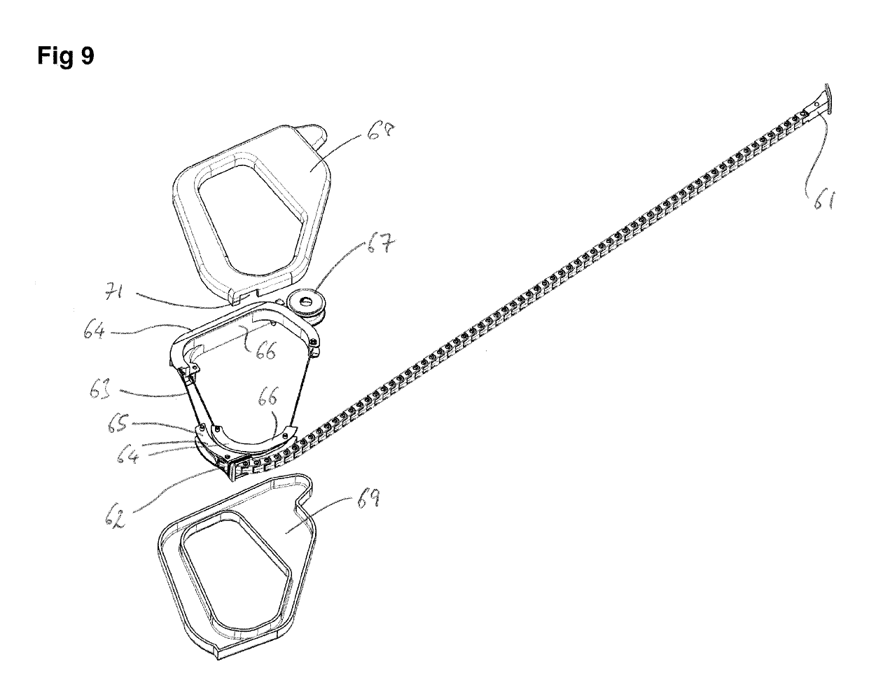

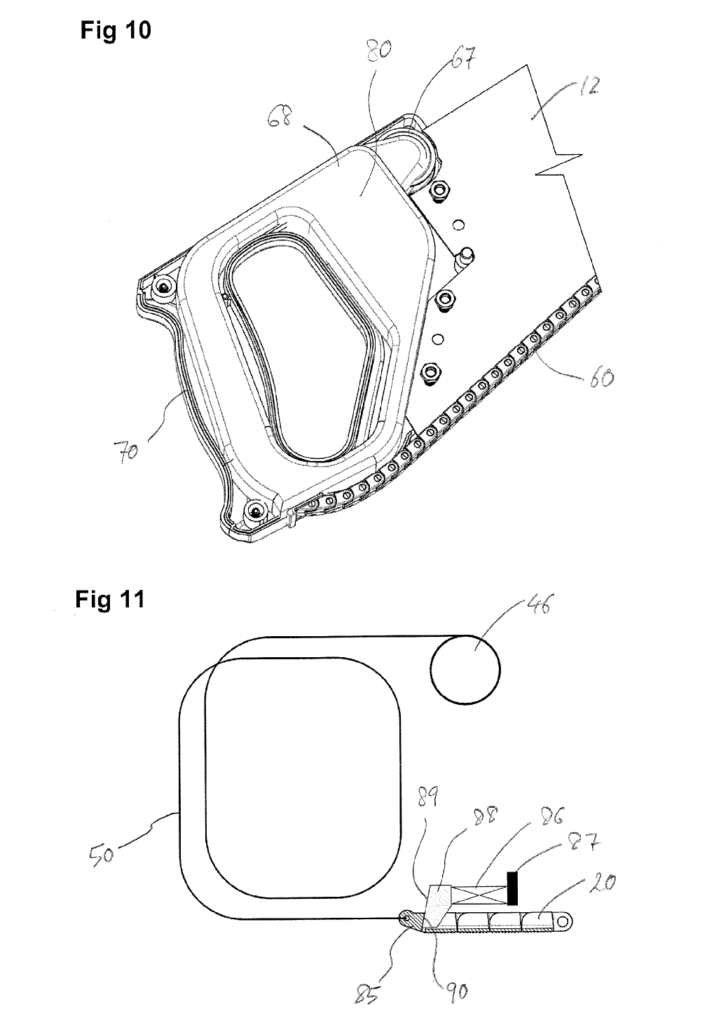

The embodiment illustrated in FIGS. 7 and 8 requires the handle parts 35 and 36 to be configured for receipt of the spool 46 and the tracks 47. In an alternative version of the invention, the retraction mechanism can be enclosed within a cassette or cartridge which can be inserted into the handle of a saw. This means that the internal configuration of the handle parts can remain as presently configured, but the invention can be embodied by the addition of the retraction cartridge. An exploded view of a suitable cartridge is illustrated in FIG. 9 and is shown inserted into one part of a two part handle in FIG. 10.

Referring to FIG. 9, a saw guard 60 is illustrated having an end connector 61 and a proximal end 62 to which a line 63 is attached. Tracks 64 comprising an entry track 65 and first and second guide tracks 66 provide a path for guiding the line 63 and the guard 60 when the guard 60 is to be retracted or extended. The tracks 64 and the line 63 feed to a spool 67 which is sprung by a coil spring for the application of a bias load to retract the saw guard 60.

The arrangement discussed above is very similar to that illustrated in FIGS. 7 and 8, in that the path the line 63 takes is the same as the line 50 takes in FIGS. 7 and 8. However, in FIG. 9, housing parts 68 and 69 are connectable together to enclose the line 63, the tracks 64 and the spool 67. Once connected together, the housing parts form an overall housing 80 which is shown in FIG. 10 and which is insertable into a handle 70 of FIG. 10. The arrangement of FIGS. 9 and 10 advantageously means that existing two-part handles that are applied to saws in general can be arranged to accommodate a cartridge arrangement of the kind illustrated in FIGS. 9 and 10 in order to apply the retraction mechanism of the present invention. It is not necessarily intended that the cartridge arrangement of FIGS. 9 and 10 be retrofitable to existing handle arrangements, but rather, that existing handle arrangements can be slightly modified to incorporate an opening 71 (see FIG. 9) in the housing part 68 to allow passage of the saw guard 60, but thereafter, no further modifications to the existing housing paths are required.

In the alternative, the use of a cartridge assembly means that the cartridge can be assembled and provided to the manufacturers or assemblers of saws so that the cartridge can simply be inserted in the handle when the handle is assembled, rather than the arrangement of the earlier figures, where the tracks, line and other parts are required to be inserted within the handle parts 35 and 36.

It will be evident from the figures, that a saw according to the invention can be rendered safer by the use of a saw guard. As discussed earlier herein, saw guards themselves are already known, but the present invention provides a unique and convenient guard, that is readily available to apply to the teeth of the saw blade when the saw is not in use. Likewise, removal of the saw guard is easy and convenient when the saw is to be used and there are no parts to be lost or misplaced. Moreover, the mechanism for retraction and extension of the saw guard can be applied to the handle of a saw relatively easily and inexpensively and as discussed above, the saw guard can include markings to function as a convenient tape measure.

It is noted that in FIGS. 1 to 7, the arrangement provided utilises a notch opening 31 to catch the end connector 26. In alternative arrangements, it is expected to be an option to utilise the opening 75 (see FIGS. 1, 2, 4 and 5) which is an opening that is a standard component of hand saws in particular. The opening 75 is usually provided so that the saw can be hung on a peg or nail for example when in storage, but the opening 75 also provides a point at which a modified end connector could connect and thus retain the saw guard in the guard position.

Likewise, alternative arrangements could include an end connector that engages along the upper surface 76 (see FIG. 1) at the free end 16 of the saw blade 12 so that again, a notch 31 is not required and the opening 75 is left available for mounting the saw on a pin or nail.

In the arrangements discussed above in which a spring biased spool is employed, tension in the saw guard 20 can be maintained by the spool bias. However, an alternative arrangement has been developed in order to relieve the spool from the requirement of maintaining this saw guard tension. FIG. 11 illustrates in schematic form, one arrangement in which spring bias is applied by a separate mechanism to the saw guard. Thus in FIG. 11, the saw guard 20 (illustrated only partially) includes an end connector 85 that connects to the line 50 that connects to the spool 46. The line 50 takes a different path to that of the earlier figures, but this is simply to illustrate that the path can vary depending on the configuration of the saw and the handle. The line 50 is shown in a substantially fully extended position, so that the saw guard 20 is also in an extended position either fixed in place over the edge 14 of the saw blade 12 of the earlier figures, or ready to be placed in that position.

The biasing mechanism which is shown in FIG. 11 includes a spring 86 that bears against a fixed abutment 87 that can be a surface provided within the handle 11 of a saw 10. The opposite end of the spring 86 is attached to a sliding stop 88 and that stop 88 includes a front baring surface 89 that engages at a bottom end thereof against a facing surface 90 formed by the connector 85.

The arrangement of FIG. 11 is such that as the saw guard 20 is paid out under the bias of the spool 46, the end connector 85 moves through the path of the line 50 until the saw guard has reached the position at which it can assume the guard position (see FIGS. 2 and 6). At that position, the surface 90 of the end connector 85 has already engaged with the surface 89 of the sliding stop 88 and so the surface 90 tends to push the sliding stop 88 towards the abutment 87 against the bias of the spring 86. Thus, once the end connector 26 of the saw guard 20 is placed in position in engagement with the notch 31, tension applied to the saw guard 20 is then applied by the spring 86 rather than the spool 46. This arrangement means that the tension that is applied to the saw guard 20 in the guard position can be determined by the spring constant of the spring 86 that the tension is no longer dependant on that exerted by the spool 46. All the spool 46 is required to do is to have sufficient tension to retract the saw guard 20, but not to retain tension in the saw guard 20 in the guard position.

The secondary tension arrangement discussed above can be fully enclosed within the handle 11 and as soon as the end connector 26 is disconnected from the notch 31, the saw guard 20 can be retracted to within the handle 11 as described above, via the tension exerted by the spool 46.

The invention described herein is susceptible to variations, modifications and/or additions other than those specifically described and it is to be understood that the invention includes all such variations, modifications and/or additions which fall within the spirit and scope of the present disclosure.

1. A saw having a handle and a blade projecting from the handle, the blade having an edge along which a plurality of saw teeth project, the saw further including a flexible and retractable saw guard which is connected to the saw and which is retractable from a guard position in which the saw guard overlies the saw teeth and a retracted position in which the saw teeth are exposed.

2. A saw according to claim 1, the saw guard being connectable in the guard position to an end of the saw blade remote from the handle.

3. A saw according to claim 2, the end of the saw blade remote from the handle being an end edge of the saw blade.

4. A saw according to claim 3, the end edge of the saw blade being at the end of the edge along which the plurality of saw teeth project.

5. A saw according to claim 3, the end edge of the saw blade being an edge that extends laterally to the edge along which the plurality of saw teeth project.

6. A saw according to claim 3, the end edge of the saw blade being an edge which is opposite to the edge along which the plurality of saw teeth project.

7. A saw according to claim 2, the saw guard including an end connector for connection to an end of the saw blade remote from the handle.

8. A saw according to claim 7, the end connector being operable to releasably cooperate with a notch, recess or opening formed in the saw blade in the guard position.

9. A saw according to claim 1, the saw guard having a channel into which the edge along which the plurality of saw teeth project extends in the guard position.

10. A saw according to claim 9, facing surfaces of the channel gripping opposite side surfaces of the saw blade in the guard position.

11. A saw according to claim 1, the saw including a frame that extends from the handle to an end of the saw blade remote from the handle and the saw guard being connectable in the guard position to a portion of the frame remote from the handle.

12. A saw according to claim 1, including a retraction mechanism which connects the saw guard to the saw and which facilitates retraction of the saw blade from the guard position.

13. (canceled)

14. (canceled)

15. A saw according to claim 12, the retraction mechanism including a spring biased spool for retracting the saw guard and which applies a permanent retraction load on the saw guard.

16. (canceled)

17. (canceled)

18. A saw according to claim 1, the handle being hollow or semi hollow and the saw guard being retracted to within the handle in the retracted position.

19. (canceled)

20. (canceled)

21. A saw according to claim 18, a track being housed within the interior of the handle about which the saw guard is retracted and the track being arranged so that the saw guard forms a loop, coil or spiral within the interior of the handle in the retracted position.

22. (canceled)

23. (canceled)

24. A saw according to claim 1, including a tensioning device to apply tension to the saw guard when the saw guard is in the guard position.

25. A saw according to claim 24, each of the tensioning device and the saw guard including abutments for cooperating engagement in the guard position of the saw guard, the abutment of the tensioning device being biased in a direction to apply tension to the saw guard when the saw guard is in the guard position and the abutments of the tensioning device and the saw guard engaging during extension of the saw guard to the guard position.

26. A saw according to claim 24, each of the tensioning device and the saw guard including abutments for cooperating engagement in the guard position of the saw guard, the abutment of the tensioning device being biased in a direction to apply tension to the saw guard when the saw guard is in the guard position and the abutments of the tensioning device and the saw guard engaging upon the saw guard reaching the guard position.

27. A saw according to claim 25, the abutment of the tensioning device being biased by a coil spring.

28. A saw according to claim 27, the coil spring being mounted at one end against an abutment of the saw handle and against the opposite end against the abutment of the tensioning device.

29. (canceled)
